(19) United States
(12) Patent Application Publication
(10) Pub. No.: US 2026/0210453 A1
(43) Pub. Date: Jul. 23, 2026

(54) PRESSURE CONTROL VALVE FOR THE OPEN-LOOP OR CLOSED-LOOP CONTROL OF A PRESSURE OF A FLUID IN A PILOT PRESSURE CHAMBER, AND VIBRATION DAMPER HAVING SUCH A PRESSURE CONTROL VALVE

(71) Applicant: Solero Technologies Villingen GmbH, Villingen-Schwenningen (DE)

(72) Inventors: Björn BERGFELD, Balingen-Endingen (DE); Stefan DISCH, Schonach (DE); Joachim FLÜHS, Villingen-Schwenningen (DE)

(21) Appl. No.: 19/135,934

(22) PCT Filed: Feb. 6, 2024
(86) PCT No.: PCT/EP2024/052861

§ 371 Date: Jun. 5, 2025

(30) Foreign Application Priority Data
May 15, 2023 (DE) 102023112797.7

(51) Int. Cl. F16K 27/02; F16F 9/46; F16F 13/00; F16K 31/40

(52) U.S. Cl. CPC F16K 27/029; F16F 9/46; F16F 13/007; F16K 31/40

(57) ABSTRACT

The present invention relates to a pressure control valve for the open-loop or closed-loop control of a pressure of a fluid in a pilot pressure chamber. The pressure control valve includes a valve housing with at least one inlet, which is fluidically connectable to the pilot pressure chamber, and at least one outlet, and, between the at least one inlet and at least one outlet, a first valve seat and a second valve seat, which are arranged in a pilot valve chamber, having a tappet with a pilot seal, wherein the tappet is movable along a longitudinal axis by means of an energizable actuating device, wherein the pilot seal has a sealing portion with a first sealing face and a second sealing face which are arranged on opposite sides along the longitudinal axis.

### CROSS-REFERENCE TO RELATED APPLICATIONS

This application is the National Stage of International Application No. PCT/EP 2024/052861 filed on Feb. 6, 2024, which claims priority to and all advantages of German Patent Application No. 10 2023 112 797.7 filed on May 15, 2023, the disclosures of which are hereby incorporated by reference in their entirety.

### BACKGROUND

The present invention relates to a pressure control valve for the open-loop or closed-loop control of a pressure of a fluid in a pilot pressure chamber. Furthermore, the present invention relates to a vibration damper having such a pressure control valve.

Pressure control valves are known from the prior art in various designs. For example, in the prior art, pressure control valves of the same type are used in vibration dampers in motor vehicles, wherein a damping characteristic of the pressure control valve depends on a volume flow of the fluid used flowing through the proportional valve. Depending on the volume flow, a more comfort-oriented softer damping or a more sporty harder damping can be set. Vibration dampers use an energizable actuating device with which several damping characteristics can be preset by the driver or automatically set by an on-board computer depending on the driving condition of the vehicle or the condition of the floor covering along which the vehicle is currently moving.

The fluid can be hydraulic or pneumatic, wherein hydraulic fluid or compressed air is usually used. Pilot pressure chambers in hydraulically or pneumatically operated devices are used to open-loop or closed-loop control pilot-operated valves, often also designed as hydraulic or pneumatic gate valves. If pilot-operated valves are designed as proportional valves or proportional gate valves, the flow rates through the proportional valve or proportional gate valve can be continuously adjusted within certain limits using the pressure in the pilot pressure chamber.

Such pressure control valves have proven their worth in the past, but it must be ensured at all times that a fail-safe device, also known as a “failsafe”, is available in the event of an electrical power failure and consequently a failure of the pressure control valve's actuating device. This ensures that the vehicle can continue to be operated with a certain damping characteristic even in the event of a power failure. A medium damping characteristic that is neither too hard nor too soft is usually aimed for.

These requirements result in a relatively complex design of the device, in particular the vibration damper, as can be seen, for example, in US 2016 0 091 044 A1 and WO 2016 066 314 A1. The design is primarily complex because several gate valves have to be used. Further vibration dampers are disclosed in US 2016 0 369 862 A1, JP 2009 115 319 A, U.S. Pat. No. 5,147,018 A, WO 2011 023 351 A1 and US 2005 0 016 086 A1. In particular, the vibration damper disclosed in EP 2 678 581 B1 also offers a medium damping characteristic in the “failsafe” mode.

A disadvantage of the pressure control valves known from the prior art is that the open-loop or closed-loop controlling of the fluid pressure varies greatly in the lowest control range, which means that the damping behavior can vary greatly, particularly when the actuating device is supplied with a low current.

### SUMMARY

The present invention is dedicated to the object of proposing a generic pressure control valve which expediently eliminates the disadvantages known from the prior art. The pressure control valve to be proposed should enable a repeatable adjustment of the damping behavior even with a low current flow in the lowest control range. A further object is to specify a pressure control valve for regulating the pressure of a fluid in a pilot pressure chamber, which is simple in design and regulates the pressure in the pilot pressure chamber to a determinable value even if no electrical energy is available to energize the actuating device. Furthermore, one embodiment of the present invention is based on the object of creating a device with which the pressure of the fluid in the pilot pressure chamber can be regulated and which can be operated with such a pressure control valve.

This object is achieved by a pressure control valve and a vibration damper in accordance with embodiments of the present invention.

Generic pressure control valves, for open-loop control or closed-loop control of a pressure of a fluid in a pilot pressure chamber, have a valve housing with at least one inlet and at least one outlet. The at least one inlet is fluidically connectable to the pilot pressure chamber. In addition, the valve housing has a first valve seat arranged between the at least one inlet and the at least one outlet and a second valve seat arranged in a pilot valve chamber. The pilot pressure chamber is connected to the at least one outlet by means of a first through-channel and to the at least one inlet by means of a second through-channel. In addition, the pressure control valve according to the invention has a tappet with a pilot seal, wherein the tappet is movable along a longitudinal axis between a first and a second position by means of an actuating device which can be energized. The pilot seal comprises a sealing portion with a first sealing face and a second sealing face, wherein the first sealing face and the second sealing face are arranged on opposite sides along the longitudinal axis. In an unactuated state of the actuating device, by means of a restoring spring, the pilot seal is arranged in the first position, in which the first sealing face of the pilot seal bears sealingly against the first valve seat and closes the first through-channel. In the actuated state of the actuating device, the tappet is in the second position, in which the second sealing face of the pilot seal bears sealingly against the second valve seat and closes the second through-channel. According to the invention, however, it is provided that the pilot seal has a stop portion that is spring-mounted with respect to the sealing portion and which can come to bear against a stop between the first end position and a second end position before the second end position is reached.

The present invention is based on the idea of proposing a pressure control valve that enables comfortable damping behavior.

When the actuating device is slightly energized, for example with approx. 0.4 A, the tappet with the pilot seal is moved from the first position towards the second end position. The pilot seal first comes into contact with a stop and comes to bear there in a position referred to here as the contact position of the tappet. In this position, the fluid can flow from the at least one inlet through the second through-channel into the pilot valve chamber and can flow out through the first through-channel in the direction of the at least one outlet.

If the actuating device is energized more strongly, the pilot seal is overpressed and the second valve seat, which can also be called the pilot seat, is closed. In other words, the sealing portion is displaced, in particular elastically, relative to the stop portion and the sealing portion, or more precisely the second sealing face, bears sealingly against the second valve seat and closes the second through-channel. In this state, the fluid is unable to flow from the at least one inlet through the pilot valve chamber to the at least one outlet.

A further development of the present invention provides that in the first position, i.e. in the unactuated state of the actuating device, a first distance measured in the longitudinal axis between the second sealing face and the second valve seat is greater than a second distance measured in the longitudinal axis between the stop portion and the stop. Thus, in an undeformed state of the pilot seal, the second sealing face is arranged at a distance from the second valve seat even when the stop portion bears against the stop. The fluid can therefore flow from the at least one inlet through the second through-channel.

A further development of the present invention provides that the pilot seal has at least one passage opening through which flow can occur. The at least one passage opening through which flow can occur is preferably formed on the other side of the sealing portion and is further preferably formed at least between the sealing portion and the stop portion. The at least one passage opening through which flow can occur can also extend over the stop section, either completely or partially. In the bearing position, the fluid can flow through the pilot seal via at least one passage opening through which flow can occur. The at least one passage opening through which flow can occur can be of any shape and allows fluid communication between the opposite sides of the pilot seal along the longitudinal axis.

In addition, it has proven to be advantageous if the pilot seal has a spring portion. Preferably, the spring portion connects the stop portion and the sealing portion and enables a spring-elastic displacement of the sealing portion relative to the stop portion. In a preferred embodiment, the spring portion can be designed as a web connecting the stop portion and the sealing portion.

According to a further preferred embodiment, the pilot seal comprises a disk-shaped flat spring element. In particular, it is preferred if the stop portion, the spring portion and at least partially the sealing portion are formed in one piece, preferably as a disk-shaped element. Disk-shaped flat spring elements can be easily designed for the respective application and can be manufactured easily and cost-effectively. Such disk-shaped flat spring elements have also proven to be reliable.

A further development of the present invention provides that the pilot seal has a sealing element comprising the first sealing face and/or a sealing element comprising the second sealing face. In particular, it is preferable if a sealing element is arranged on opposite sides of the disk-shaped flat spring element along the longitudinal axis. The shape of the respective sealing element can be adapted to the shape of the respective valve seat, wherein the respective sealing element is preferably circular or annular. Furthermore, it is preferred if the two sealing elements are of the same design.

According to a further preferred embodiment, the pilot valve chamber is formed in the valve housing, wherein the pilot valve chamber is preferably enclosed by the valve housing. In the pilot valve chamber, the first valve seat and the second valve seat are arranged in the longitudinal axis on opposite sides of the valve housing, wherein the first valve seat frames or surrounds an opening of the first through-channel and the second valve seat frames or surrounds an opening of the second through-channel.

It has also proven to be advantageous if the valve housing comprises a wall portion that has the first valve seat and the first through-channel. The wall portion can be designed in the manner of a valve housing and preferably close off the pilot valve chamber on one side along the longitudinal axis, resulting in an advantageous design of the valve housing.

Furthermore, it has proven to be advantageous if the wall portion has at least one passage bore that forms a bypass around the first valve seat. The bypass enables fluid communication between the pilot valve chamber and a side of the wall portion facing away from the pilot valve chamber both in the first position and in the second position of the tappet, and enables fluid communication between the pilot valve chamber and the at least one outlet, in particular when the tappet is in the first position and the pilot seal bears sealingly against the first valve seat.

Furthermore, it has proven to be advantageous if a failsafe seal is arranged on the side of the wall portion facing away from the first valve seat, which is preloaded against the wall portion and can bear against the wall portion in such a manner that the passage bore is closed. The failsafe seal, which is preloaded against the wall section, can provide a pressure in the pilot valve chamber at which the passage bore is released and the fluid can flow from the pilot valve chamber through the passage bore to the at least one outlet. The passage bore and the failsafe seal interacting with the passage bore ensure that the shock absorber can continue to operate with a specific damping characteristic even in the event of a power failure. The damping characteristic can be defined by selecting the preload of the failsafe seal, wherein said damping characteristic is typically selected in such a manner that it is neither too hard nor too soft.

An advantageous further development of the present invention provides that the wall portion is formed by a valve housing cover part. The valve housing cover part can, for example, be designed as a disk-shaped component and, together with a main valve housing part, enclose the pilot valve chamber at least in certain areas.

A further development of the present invention provides that the valve housing comprises a second wall portion comprising the second valve seat or the stop and the second valve seat. The second wall portion can also comprise the second through-channel, wherein the second through-channel is preferably formed as a bore. The second wall portion is preferably arranged in the longitudinal axis on the side of the valve housing opposite the first wall portion, wherein the second wall portion may be integrally formed with the main valve housing part. According to an exemplary embodiment, for example, the stop can be formed on the main valve housing part and the second valve seat on the second wall portion. According to another exemplary embodiment, both the stop and the second valve seat can be formed on the second wall portion.

According to a further development of the present invention, the second wall portion comprises an insert bushing. In particular, the insert bushing can be inserted into a corresponding opening along the longitudinal axis in the main valve housing part in the manner of a press-fit bushing, whereby the position of the second valve seat can be precisely adjusted along the longitudinal axis. In particular, when inserting the insert bushing, if the stop is not formed on the insert bushing, the position of the second valve seat in the longitudinal axis, in particular with respect to the stop, can be set precisely.

A preferred further development of the present invention provides that the second valve seat and/or the stop have at least one bypass channel. The respective bypass channel can preferably be designed in the form of a groove or recess and allows the fluid to flow through, in particular when the second sealing face bears against the second valve seat in the second position or when the stop section bears against the stop.

According to a further development of the present invention, the valve housing comprises a main valve chamber. The main valve chamber is fluidically connected to the at least one inlet and the at least one outlet. Preferably, a main valve gate valve preloaded against a main valve seat by means of a main spring can be arranged in the main valve chamber. Preferably, the pilot valve chamber is fluidically connected to the main valve chamber by means of the second through-channel, allowing the fluid to flow from the inlet through the main valve chamber via the second through-channel and the pilot valve chamber to the at least one outlet.

A further development of the present invention provides for the main gate valve to be designed as a proportional gate valve.

Another aspect of the present invention relates to a vibration damper with a pressure control valve as described above.

### BRIEF DESCRIPTION OF THE DRAWINGS

With reference to the accompanying drawings, three exemplary embodiments of a pressure control valve according to the invention are described in detail below. In the figures:

FIG. 1 is a sectional view of a pressure control valve with an energizable actuating device, comprising a tappet and a pilot seal arranged on the tappet, wherein an actuating device is de-energized and, in a first position, the pilot seal bears sealingly against a first valve seat in a pilot valve chamber,

FIG. 2 is an enlarged detailed view of the pressure control valve according to FIG. 1, wherein the actuating device is slightly energized and the pilot seal in this position bears against a stop in the pilot valve chamber,

FIG. 3 is an enlarged detailed view of the pressure control valve according to FIG. 1 or 2, wherein the actuating device is energized more strongly and, in a second position, the pilot seal is pushed through in such a manner that the pilot seal bears sealingly against a second valve seat in the pilot chamber,

FIG. 4 is an enlarged sectional view of a second exemplary embodiment of the pressure control valve in the de-energized state analogous to FIG. 1,

FIG. 5 is an enlarged sectional view of a second exemplary embodiment of the pressure control valve according to FIG. 4, wherein the actuating device is slightly energized as in FIG. 2,

FIG. 6 is an enlarged sectional view of a third exemplary embodiment in the de-energized state of the actuating device analogous to FIG. 1,

FIG. 7 is an enlarged sectional view of a third exemplary embodiment of the pressure control valve according to FIG. 6, wherein the actuating device is slightly energized as in FIG. 2,

FIG. 8 is an enlarged sectional view of a fourth exemplary embodiment in the de-energized state of the actuating device analogous to FIG. 1,

FIG. 9 is an enlarged sectional view of a fourth exemplary embodiment of the pressure control valve according to FIG. 8, wherein the actuating device is slightly energized as in FIG. 2,

FIG. 10 is an enlarged view of the pilot seal, and

FIG. 11 is an enlarged view of a further development of the pilot seal according to FIG. 7.

Identical or functionally identical parts or features are identified with the same reference signs in the following detailed description of the figures. Similarly, not all identical or functionally identical parts or features are given a reference number in the figures.

### DETAILED DESCRIPTION

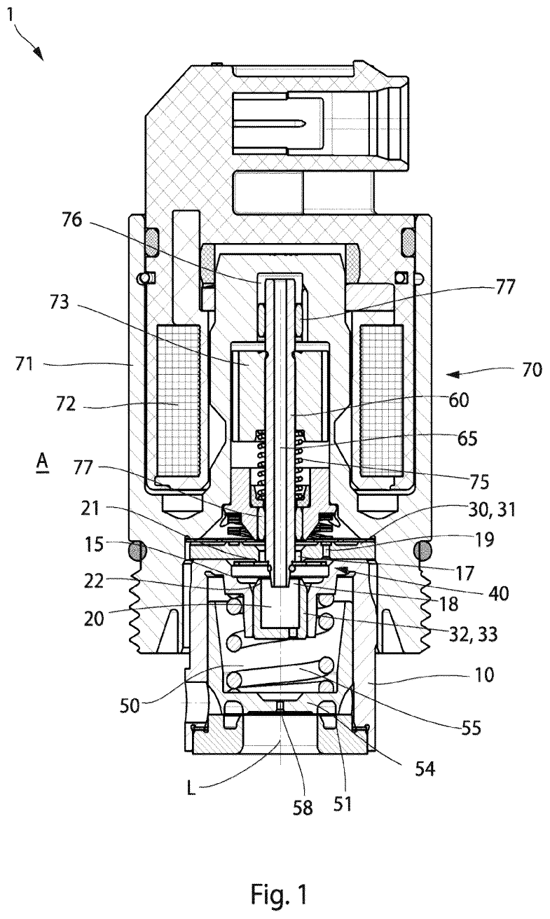

First, a first exemplary embodiment is described in detail below with reference to FIGS. 1-3. Subsequently, the other exemplary embodiments will be briefly described, focusing only on the differences from the previous exemplary embodiments. At this point, it should be noted that the features of the exemplary embodiments and also of the further developments can be combined with one another.

FIG. 1 shows a first exemplary embodiment of a pressure control valve 1 for open-loop or closed-loop control of the pressure of a fluid. The pressure control valve 1 can be used, for example, in a vibration damper (not shown), in particular of a motor vehicle, to adjust a damping characteristic of the vibration damper.

The pressure control valve 1 comprises a valve housing 10 with at least one inlet and at least one outlet. The at least one inlet can be connected to a pilot pressure chamber.

The valve housing 10 at least partially encloses a pilot valve chamber 20, wherein a first valve seat 21 and a second valve seat 22 are arranged in the pilot valve chamber 20. The first valve seat 21 and the second valve seat 22 are arranged on opposite sides in the valve housing 10 or, more precisely, in the pilot valve chamber 20 along the longitudinal axis L.

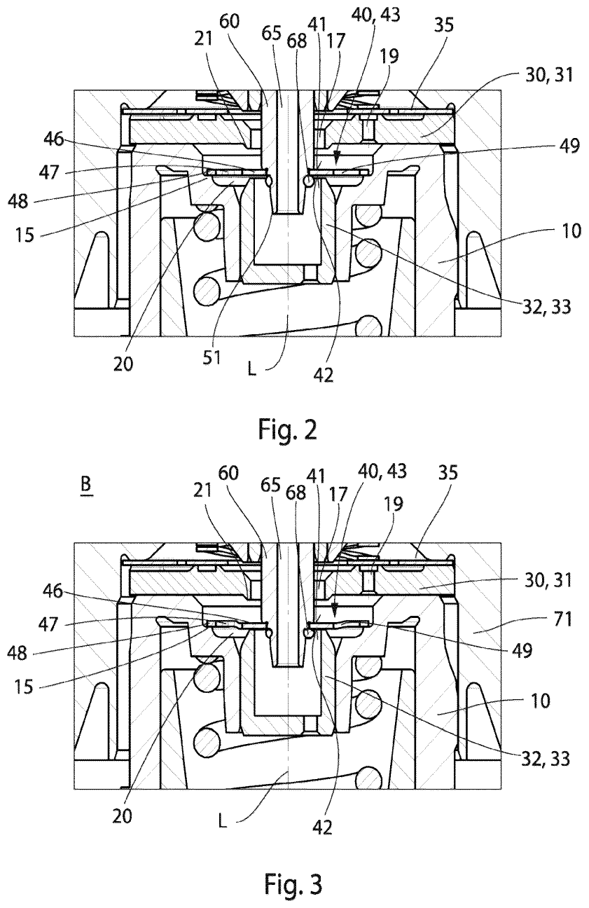

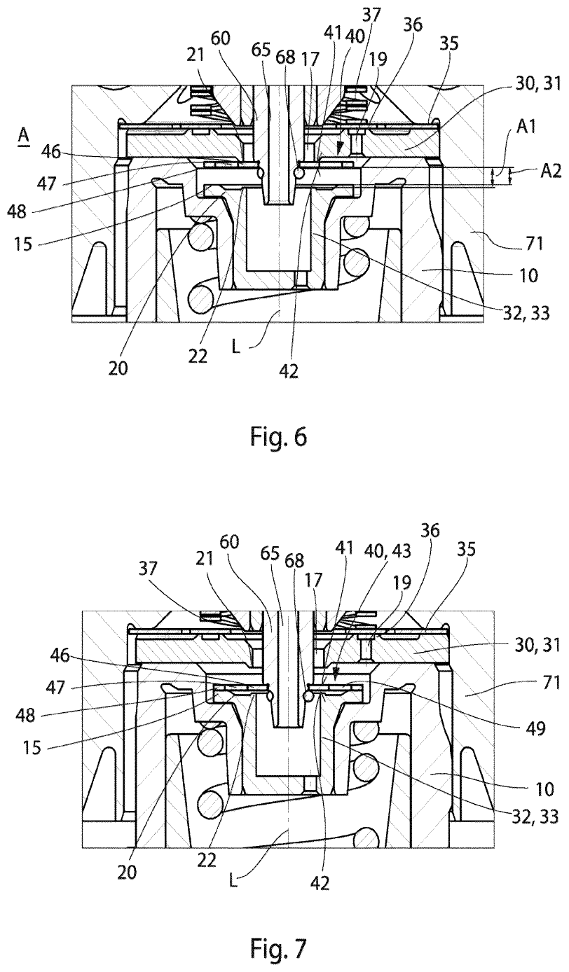

As can be seen in particular from the detailed illustrations according to FIGS. 2-9, the first valve seat 21 is arranged in a first wall portion 30 and the second valve seat 22 is arranged in a second wall portion 32.

Among other things, the pilot valve chamber 20 is connected to the at least one outlet by means of a first through-channel 17. In addition, the pilot valve chamber 20 is connected to the at least one inlet by means of a second through channel 18, whereby the fluid can flow through the at least one inlet and the second through-channel 18 into the pilot valve chamber 20 and can flow out through the first through-channel 17 to the at least one outlet.

The first wall portion 30 comprises the first through-channel 17, the first valve seat 21 and preferably a passage bore 19, which will be described in detail later. The second wall portion 32 comprises the second through-channel 18 and the second valve seat 22.

The valve housing 10 can comprise a main housing part, a valve housing cover part 31 and/or an insert bushing 33. Preferably, the valve housing cover part 31 comprises the first wall portion 30 and the insert bushing 33 comprises the second wall portion 32.

Furthermore, it can be seen from FIGS. 2 to 5 that the valve housing 10 has a stop 15 which is arranged along the longitudinal axis L between the first valve seat 21 and the second valve seat 22 in the pilot valve chamber 20. The first valve seat 21 and the second valve seat 22 are preferably formed on the same diameter in relation to the longitudinal axis L.

Furthermore, it can be seen from FIG. 1 that the valve housing 10 has a main valve chamber 50, which is fluidically connected on the one hand to the at least one inlet and on the other hand to the at least one outlet. According to the illustrated exemplary embodiment, a main valve gate valve 54 can be arranged in the main valve chamber 50, which is held preloaded against a main valve seat 51 by a main valve spring 55.

The main valve chamber 50 is fluidically arranged between the at least one inlet and the pilot valve chamber 40. This means that the fluid must first flow from the at least one inlet through the main valve chamber 50 before it can enter the pilot valve chamber 40 through the second through-channel 18. For this purpose, the main valve gate valve 54 has a passage 58, which is shown in FIG. 1.

In addition, the pressure control valve 1 has an energizable actuating device 70, wherein the one energizable actuating device 70—as in the exemplary embodiment shown-can preferably be formed by an electromagnetic actuator.

The actuating device 70 may be accommodated in an actuator housing 71, wherein the actuating device 70 also comprises an excitation coil 72, an anchor 73 and a restoring spring 75. The anchor 73 can be moved in a known manner along a longitudinal axis L when the excitation coil 72 is energized against a spring force of the restoring spring 75.

The actuator housing 71 has a receiving area into which the valve housing 10 can be at least partially inserted. The valve housing 10 can be firmly arranged in the receiving area of the actuator housing 71, for example by means of a form-fit, force-fit and/or material-fit connection.

Furthermore, the pressure control valve 1 has a tappet 60, wherein the tappet 60 can be moved along the longitudinal axis L by the actuating device 70. For this purpose, the tappet 60 is preferably connected to the anchor 73 and can also-as shown in FIG. 1—be held movably mounted on the actuator housing 71 along the longitudinal axis L by means of bearing elements 77.

The tappet 60 protrudes from the actuator housing 71 into the valve housing 10. In particular, as can be seen from the detailed illustrations of FIGS. 2 to 9, a first free end 61 of the tappet 60 protrudes into the pilot valve chamber 20.

Furthermore, it can be seen from the accompanying figures that the tappet 60 has a pressure equalization bore 65, through which the flow can pass through the tappet 60 along the longitudinal axis L. Consequently, the fluid can flow from the first free end 61 through the tappet 60 into a pressure equalization chamber 76 opposite the anchor 73, whereby pressure equalization can take place and the pressure control valve 1 can be pressure-equalized.

The tappet 60 also has a pilot seal 40 which is fixedly arranged on the tappet 60, preferably adjacent to the free end 61. For example, as shown in the accompanying figures, the pilot seal 40 may be attached to the tappet 60 by means of a securing ring 68.

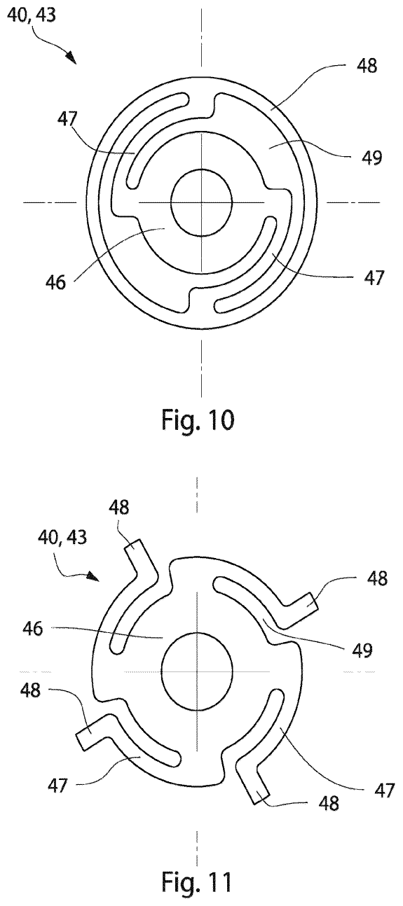

The pilot seal 40, according to the exemplary embodiments shown in FIGS. 1 to 5, is shown in detail in FIG. 10 and comprises a disk element 43. The disk element 43 is preferably designed in the form of a disk-shaped flat spring element.

The pilot seal 40 may be substantially described as an annular disk and may have a sealing portion 46, a spring portion 47 and a stop portion 48.

The sealing portion 46 and the stop portion 48 are approximately annular in shape and the stop portion 48 radially surrounds the sealing portion 46. The sealing portion 46 and the stop portion 48 are connected by a spring portion 48. The stop portion 48 can thus be elastically displaced in the longitudinal axis with respect to the sealing portion 46.

The sealing portion 46 can be described as substantially annular and, according to FIGS. 2 to 9, comprises a first sealing face 41 and a second sealing face 42 arranged in the longitudinal axis L on opposite sides of the pilot seal 40.

Furthermore, it can be seen from FIG. 10 that the pilot seal 40 has one or more passage openings 49 through which flow can occur on the other side of the sealing portion 46. The fluid can flow through the pilot seal 40 along the longitudinal axis through at least one passage opening 49.

FIG. 11 shows a further development of the pilot seal 40 according to FIG. 10. At least one, preferably two or more star-shaped spring portions 47 protrude from the sealing portion 46, each of which has a stop portion 48 at its free end. Passage openings 49 are formed in this way beyond the at least one web-shaped spring portion 47 and/or stop section portion 48, which allow fluid communication between the two opposite sides of the pilot seal 40.

In an unactuated state of the actuating device 70 according to FIGS. 1, 4, 6 and 8, the pilot seal 40 is arranged in a first position A by means of the restoring spring 75. For the sake of clarity, the figures in which the actuating device 70 is not actuated are marked with “A”. In the first position A, the first sealing face 41 bears sealingly against the first valve seat 21 and closes the first through-channel 17.

In this first position A of the pilot seal 40, the fluid cannot flow from the pilot valve chamber 20 through the first through-channel 17 in the direction of the at least one outlet. In other words, the pilot valve chamber 20 is closed on the outlet side in this first position A.

FIGS. 1, 4, 6 and 8 show the pilot seal 40 in the first position A, which corresponds to an undeformed state of the pilot seal 40. In the undeformed state of the pilot seal 40, a first distance A1—measured along the longitudinal axis L—between the second sealing face 42 and the second valve seat 22 is greater than a second distance A2—also measured along the longitudinal axis L—between the stop portion 48 and the stop 15, i.e. A1>A2.

In an actuated state of the actuating device 70, the excitation coil 72 of the actuating device 70 is energized slightly, for example by 0.4 A, and, according to FIG. 2, the pilot seal 40 is moved from the first valve seat 21 in the direction of the second valve seat 22. As shown in FIGS. 2, 5, 7 and 9, the stop portion 48 bears against the stop 15.

In this position of the pilot seal 40, the fluid can flow both from the pilot valve chamber 20 through the first through-channel 17 in the direction of the at least one outlet and from the at least one inlet through the second through-channel 18 into the pilot valve chamber 20. In the exemplary embodiment according to FIGS. 1-7, in the pilot valve chamber 20, the fluid flows through the pilot seal 40 through its at least one passage opening 49.

In a further actuated state of the actuating device 70, the excitation coil 73 of the actuating device 70 is energized more strongly and, according to FIG. 3, the pilot seal 40 is elastically deformed. As a result, the sealing portion 46 is displaced in the longitudinal axis L in the direction of the second valve seat 22 with respect the stop portion 48 bearing against the stop 15 and comes to bear against the second valve seat 22. In the second position B, the second sealing face 42 bears sealingly against the second valve seat 22 and closes the second through-channel 18.

In this second position B of the pilot seal 40, the pilot seal 40 presses sealingly against the second valve seat 22, and prevents the fluid from the at least one inlet from flowing into the pilot valve chamber 20.

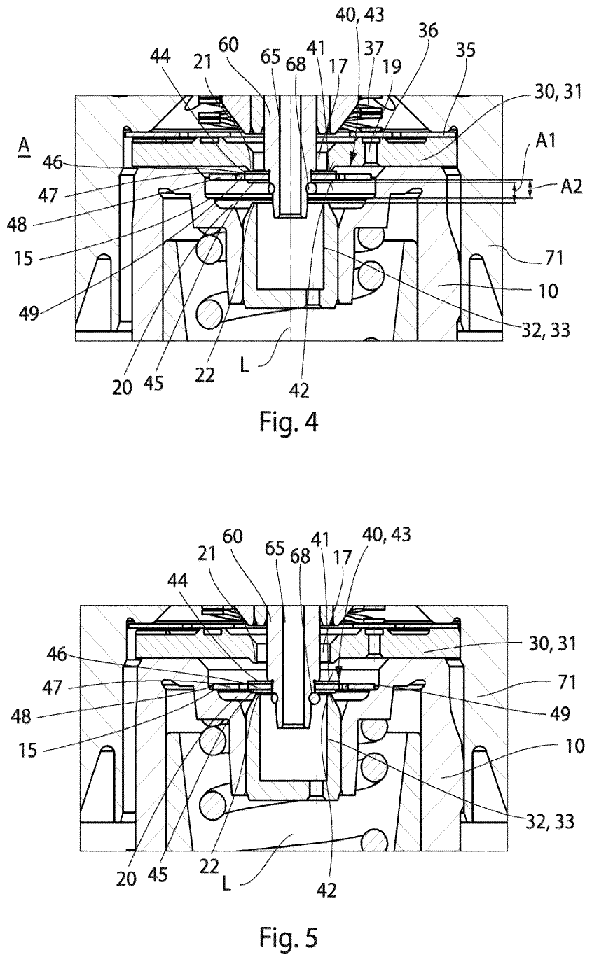

The second exemplary embodiment according to FIGS. 4 and 5 differs from the first exemplary embodiment described above in the design of the pilot seal 40. As can be seen from FIGS. 4 and 5, the pilot seal 40 comprises two sealing elements 44, 45 which are arranged on opposite sides of the disk element 43.

The two sealing elements 44, 45 can be made of a different material than the disk element 43, for example in order to exhibit improved sealing properties. The two sealing elements 44, 45 are arranged in the sealing portion 46 and form the respective sealing face 41, 42 in the sealing portion 46.

The disk element 43 and the two sealing elements 44 and 45 can be connected to one another or the disk element 43 and the two sealing elements 44 and 45 can be loosely arranged on top of one another on the tappet 60 and held there by means of the securing ring 68 in a loss-proof manner.

So that the fluid can flow through a pilot seal 40 formed in this manner, the at least one passage opening 49 is arranged radially beyond the sealing portion 46 or the sealing elements 44, 45.

The third exemplary embodiment differs in particular from the first exemplary embodiment in the design of the second wall portion 32. According to the third exemplary embodiment, the second wall portion 32 comprises the stop 15 and the second valve seat 22. The stop 15 and the second valve seat 22 can be manufactured in a joint machining step, which means that a high degree of dimensional accuracy of the positions of the stop 15 and the valve seat 22 in the longitudinal axis L can be achieved. In other words, a distance between the stop 15 and the valve seat 22 can be manufactured with dimensional accuracy.

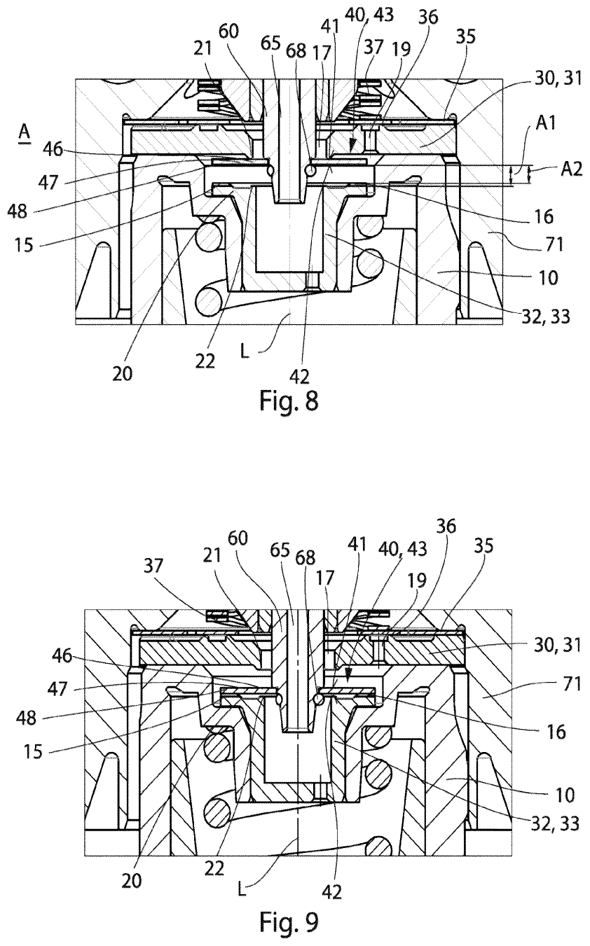

The fourth exemplary embodiment according to FIGS. 8 and 9 differs in particular from the third exemplary embodiment described above in the design of the pilot seal 40 and the stop 15.

The pilot seal 40 according to the fourth exemplary embodiment has no passage openings 49, but is designed as a continuous annular disk, comprising the sealing portion 45, the spring portion 46 and the stop portion 47. In order to allow a flow between the first valve seat and the second valve seat 22 in the pilot valve chamber 20, at least one bypass channel 16 designed in the form of a groove is arranged in the stop 15. When the stop portion 48 is in contact with the stop 15, the fluid can flow past the pilot seal 40 through the at least one bypass channel 16.

All the exemplary embodiments described above also have in common that a failsafe seal 35 is arranged on the side of the first wall portion 30 facing away from the pilot valve chamber 20. The failsafe seal 35 is held preloaded against the first wall portion 30 and bears sealingly against a failsafe seat 36 with the passage bore 19.

The failsafe seal 35 can be designed as a disk-shaped flat spring element and can also be arranged between the first wall portion 30 and the actuator housing 71.

The preload of the failsafe seal 35 can be achieved by a failsafe spring 37.

In addition, it can be seen from FIGS. 1 to 9 that the failsafe seat 36 can be formed by at least one annular projection. In the exemplary embodiment shown, the failsafe seat 36 is formed by two projections that are coaxial about the longitudinal axis L.

The passage bore 19 is arranged in the first wall portion 30 in such a manner that the pilot seal 40 cannot bear sealingly against the passage bore 19. In the event of an electrical power failure or when the operating device 70 is in the de-energized state, the fluid can flow out of the pilot valve chamber 20 through the passage bore 19 to the at least one outlet against the sealing effect of the failsafe seal 35, which ensures that the vehicle can continue to be operated with a certain damping characteristic even in the event of an electrical power failure, for example.

### LIST OF REFERENCE SIGNS

1 pressure control valve
10 valve housing
15 stop
16 bypass channel
17 first through-channel
18 second through-channel
19 passage bore
20 pilot valve chamber
21 first valve seat
22 second valve seat
30 first wall portion
31 valve housing cover part
32 second wall portion
33 insert bushing
35 failsafe seal
36 failsafe seat
37 failsafe spring
40 pilot seal
41 first sealing face
42 second sealing face
43 disk element
44 sealing element
45 sealing element
46 sealing portion
47 spring portion
48 stop portion
49 passage openings
50 main valve chamber
51 main valve seat
54 main valve gate valve
55 main spring
60 tappet
65 pressure equalization bore
68 securing ring
70 actuating device
71 actuator housing
72 excitation coil
73 anchor
75 restoring spring
76 pressure equalization chamber
77 bearing element
L longitudinal axis
A1 first distance
A2 second distance

The above description is that of current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A pressure control valve for the open-loop or closed-loop control of a pressure of a fluid in a pilot pressure chamber, comprising:
a valve housing with at least one inlet, which is fluidically connectable to the pilot pressure chamber, and with at least one outlet, and, between the at least one inlet and at least one outlet a first valve seat and a second valve seat which are arranged in a pilot valve chamber,
a tappet with a pilot seal wherein the tappet is movable along a longitudinal axis by an energizable actuating device,
wherein the pilot seal has a sealing portion with a first sealing face and a second sealing face which are arranged on opposite sides along the longitudinal axis,
wherein, in an unactuated state of the actuating device by a restoring spring the pilot seal is arranged in a first position in which the first sealing face bears sealingly against the first valve seat and closes a first through-channel,
wherein, in the actuated state of the actuating device the pilot seal can be arranged in a second position in which the second sealing face bears against the second valve seat and closes the second through-channel,
wherein the pilot seal has a stop portion that is spring-mounted with respect to the sealing portion and which can come to bear against a stop between the first end position of a second end position before the second end position is reached.

2. The pressure control valve according to claim 1, wherein in the first position a first distance measured along the longitudinal axis between the second sealing face and the second valve seat is greater than a second distance measured along the longitudinal axis between the stop portion and the stop.

3. The pressure control valve according to claim 1, wherein the pilot seal has at least one passage opening through which flow can occur.

4. The pressure control valve according to claim 1, wherein the pilot seal has a spring portion.

5. The pressure control valve according to claim 1, wherein the spring portion is arranged between the sealing portion and the stop portion.

6. The pressure control valve according to claim 1, wherein the pilot seal comprises a disk-shaped flat spring element.

7. The pressure control valve according to claim 1, wherein the pilot seal comprises a sealing element comprising the first sealing face or a sealing element comprising the second sealing face.

8. The pressure control valve according to claim 1, wherein the pilot valve chamber is formed in the valve housing and wherein the first valve seat and the second valve seat are arranged on opposite sides of the pilot valve chamber.

9. The pressure control valve according to claim 1, wherein the valve housing comprises a first wall portion which has the first valve seat and the through-channel.

10. The pressure control valve according to claim 1, wherein the first wall portion has at least one passage bore which forms a bypass around the first valve seat.

11. The pressure control valve according to claim 1, wherein a failsafe seal is arranged on the side of the first wall portion facing away from the first valve seat which failsafe seal is preloaded against the first wall portion and can close the passage bore.

12. The pressure control valve according to claim 1, wherein the wall portion is formed by a valve housing cover part.

13. The pressure control valve according to claim 1, wherein the valve housing has a second wall portion which comprises the second valve seat or the stop.

14. The pressure control valve according to claim 1, wherein the second valve seat or the stop have at least one bypass channel.

15. The pressure control valve according to claim 1, wherein the second wall portion comprises an insert bushing.

16. The pressure control valve according to claim 1, wherein the valve housing comprises a main valve chamber in which a main valve gate valve is arranged, which is preloaded against a main valve seat by a main valve spring.

17. The pressure control valve according to claim 1, wherein the main valve gate valve configured as a proportional gate valve.

18. A vibration damper having a pressure control valve according to claim 1.
